(19) United States
(12) Patent Application Publication
(10) Pub. No.: US 2018/0109454 A1
(43) Pub. Date: Apr. 19, 2018

(54) FORWARDING INFORMATION BASE ARCHITECTURE FOR A HYBRID IP AND CONTENT CENTRIC NETWORK ROUTER

(71) Applicant: CISCO TECHNOLOGY, INC., San Jose, CA (US)

(72) Inventor: Eric A. Holmberg, San Anselmo, CA (US)

(73) Assignee: CISCO TECHNOLOGY, INC., San Jose, CA (US)

(21) Appl. No.: 15/297,061

(22) Filed: Oct. 18, 2016

(51) Int. Cl. H04L 12/743; H04L 12/745

(52) U.S. Cl. CPC H04L 45/7457; H04L 45/748; H04L 45/7453

(57) ABSTRACT

One embodiment provides a system that facilitates forwarding a mix of IP and CCN packets. During operation, the system determines a name which is a hierarchically structured variable length identifier comprising contiguous name components ordered from a most general level to a most specific level. The system is capable of processing packets based on a destination address. The system performs a hash of each name component. The system creates an entry in a first data structure for each hashed name component, wherein a respective entry indicates an index and a length of the index. The system maps, in a forwarding information base, a first key to one or more outgoing interfaces, wherein the first key is a concatenation of the indexes indicated in the created entries, thereby facilitating the system to process packets based on the packet name or on the destination address.

### RELATED APPLICATIONS

The subject matter of this application is related to the subject matter in the following applications:

U.S. patent application Ser. No. 13/847,814 (Attorney Docket No. PARC-20120537-US-NP), entitled “ORDERED-ELEMENT NAMING FOR NAME-BASED PACKET FORWARDING,” by inventor Ignacio Solis, filed 20 Mar. 2013 (hereinafter “U.S. patent application Ser. No. 13/847,814”);

U.S. patent application Ser. No. 12/338,175 (Attorney Docket No. PARC-20080626-US-NP), entitled “CONTROLLING THE SPREAD OF INTERESTS AND CONTENT IN A CONTENT CENTRIC NETWORK,” by inventors Van L. Jacobson and Diana K. Smetters, filed 18 Dec. 2008 (hereinafter “U.S. patent application No. 12/338,175”); and

U.S. patent application Ser. No. 14/579,925 (Attorney Docket No. PARC-20141109US01), entitled “SYSTEM AND METHOD FOR EFFICIENT NAME-BASED CONTENT ROUTING USING LINK-STATE INFORMATION IN INFORMATION-CENTRIC NETWORKS,” by inventor Jose J. Garcia-Luna-Aceves, filed 22 Dec. 2014 (hereinafter “U.S. patent application Ser. No. 14/579,925”);

the disclosures of which are herein incorporated by reference in their entirety.

### BACKGROUND

### Field

This disclosure is generally related to distribution of digital content. More specifically, this disclosure is related to a system and architecture of a forwarding information base for a router which can process both address-based IP packets and name-based content centric network (CCN) packets.

### Related Art

The proliferation of the Internet and e-commerce continues to create a vast amount of digital content. Content centric network (CCN) architectures have been designed to facilitate accessing and processing such digital content. A CCN includes entities, or nodes, such as network clients, forwarders (e.g., routers), and content producers, which communicate with each other by sending interest packets for various content items and receiving content object packets in return. CCN interests and content objects are identified by their unique names, which are typically hierarchically structured variable length identifiers (HSVLI). An HSVLI can include contiguous name components ordered from a most general level to a most specific level.

A CCN packet (e.g., an interest or a content object) is routed based on its unique name, while an IP packet is routed based on a destination IP address. Currently, many telecom providers make extensive use of edge and core routers, which forward, edit, and manage IP packets at extremely high rates. These routers (i.e., IP routers) process IP packets based on the destination address indicated in a respective IP packet. These IP routers are currently unable to process CCN packets, that is, based on the name indicated in a respective CCN packet. In order for telecom providers to deploy CCN (i.e., forward, edit, and manage CCN traffic) using currently existing IP routers, the routers require functionality to process both IP and CCN packets at similar rates.

### SUMMARY

One embodiment provides a system that facilitates forwarding a mix of IP and CCN packets. During operation, the system determines a name which is a hierarchically structured variable length identifier comprising contiguous name components ordered from a most general level to a most specific level. The system is capable of processing packets based on a destination address. The system performs a hash of each name component. The system creates an entry in a first data structure for each hashed name component, wherein a respective entry indicates an index and a length of the index. The system maps, in a forwarding information base, a first key to one or more outgoing interfaces, wherein the first key is a concatenation of the indexes indicated in the created entries, thereby facilitating the system to process packets based on the packet name or on the destination address.

In some embodiments, the respective entry indicates a final predetermined number of bytes of a respective name component, the hash is a dual hash function, and performing the hash further comprises: in response to determining a collision in the first data structure, resolving the collision based on a cuckoo hash function or a collision avoidance table.

In some embodiments, the system generates the key by concatenating the indexes in a same order as the corresponding name components of the name.

In some embodiments, the forwarding information base is based on a Ternary Content Addressable Memory.

In some embodiments, the system receives a packet which includes the name and performs the hash of each name component. The system performs a first lookup in the first data structure based on each hashed name component to obtain the indicated index for each hashed name component. The system performs a second lookup in the forwarding information base based on a second key which is a concatenation of the indicated indexes, and further based on a longest prefix match which has a largest number of matching indexes of the key with indexes in the forwarding information base, to determine one or more outgoing interfaces for the packet. The system forwards the packet to the determined one or more outgoing interfaces.

In some embodiments, performing the first lookup is further based on the last H bytes of each hashed name component and the last N bytes of the name component, wherein H is a first predetermined number, and wherein N is a second predetermined number.

In some embodiments, obtaining the indicated index for a respective hashed name component further involves: obtaining a valid tuple comprised of the index, the length of the index, and the last N bytes of the respective name component; and determining that the last N bytes of the respective name component of the valid tuple match the last N bytes of the respective name component.

### BRIEF DESCRIPTION OF THE FIGURES

FIG. 1A illustrates an exemplary network which facilitates forwarding an IP packet based on a destination address, in accordance with the prior art.

FIG. 1B illustrates an exemplary table of FIB lookups in IPv4, IPv6, and CCN, in accordance with the prior art.

FIG. 1C illustrates an exemplary network which facilitates forwarding a mix of IP packets and CCN packets, including control plane activity, in accordance with an embodiment of the present invention.

FIG. 1D illustrates an exemplary network which facilitates forwarding a mix of IP packets and CCN packets, including data plane activity, in accordance with an embodiment of the present invention.

FIG. 2A illustrates an exemplary CCN interest, in accordance with an embodiment of the present invention.

FIG. 2B illustrates an exemplary component index table, in accordance with an embodiment of the present invention.

FIG. 2C illustrates an exemplary key based on the name for the interest in FIG. 2A, in accordance with an embodiment of the present invention.

FIG. 2D illustrates an exemplary key based on the name for the interest in FIG. 2A, in accordance with an embodiment of the present invention.

FIG. 2E illustrates an exemplary key based on the name for the interest in FIG. 2A, in accordance with an embodiment of the present invention.

FIG. 2F illustrates an exemplary forwarding information base, in accordance with an embodiment of the present invention.

FIG. 3A presents a flow chart illustrating a method by a router for facilitating forwarding a mix of IP and CCN packets, including updating the FIB based on a routing protocol, in accordance with an embodiment of the present invention.

FIG. 3B presents a flow chart illustrating a method by a router for facilitating forwarding a mix of IP and CCN packets, including processing an incoming interest, in accordance with an embodiment of the present invention.

FIG. 4A presents a flow chart illustrating a method by a router for facilitating forwarding a mix of IP and CCN packets, based on a specific embodiment that includes a cuckoo hash, truncated hash values, and final bits of a respective name component, in accordance with an embodiment of the present invention.

FIG. 4B presents a flow chart illustrating a method by a router for facilitating forwarding a mix of IP and CCN packets, based on a specific embodiment that includes a cuckoo hash, truncated hash values, and final bits of a respective name component, in accordance with an embodiment of the present invention.

FIG. 5 illustrates an exemplary computer system that facilitates forwarding a mix of IP packets and CCN packets, in accordance with an embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of allowing IP routers to process a mix of both IP and CCN packets. A CCN packet (e.g., an interest or a content object) is routed based on its unique name, while an IP packet is routed based on a destination IP address. Currently, many telecom providers make extensive use of edge and core routers, which forward, edit, and manage IP packets at extremely high rates. These routers (i.e., IP routers) process IP packets based on the destination address indicated in a respective IP packet. These IP routers are currently unable to process CCN packets, that is, based on the name indicated in a respective CCN packet. In order for telecom providers to deploy CCN (i.e., forward, edit, and manage CCN traffic) using currently existing IP routers, the routers require functionality to process both IP and CCN packets at similar rates.

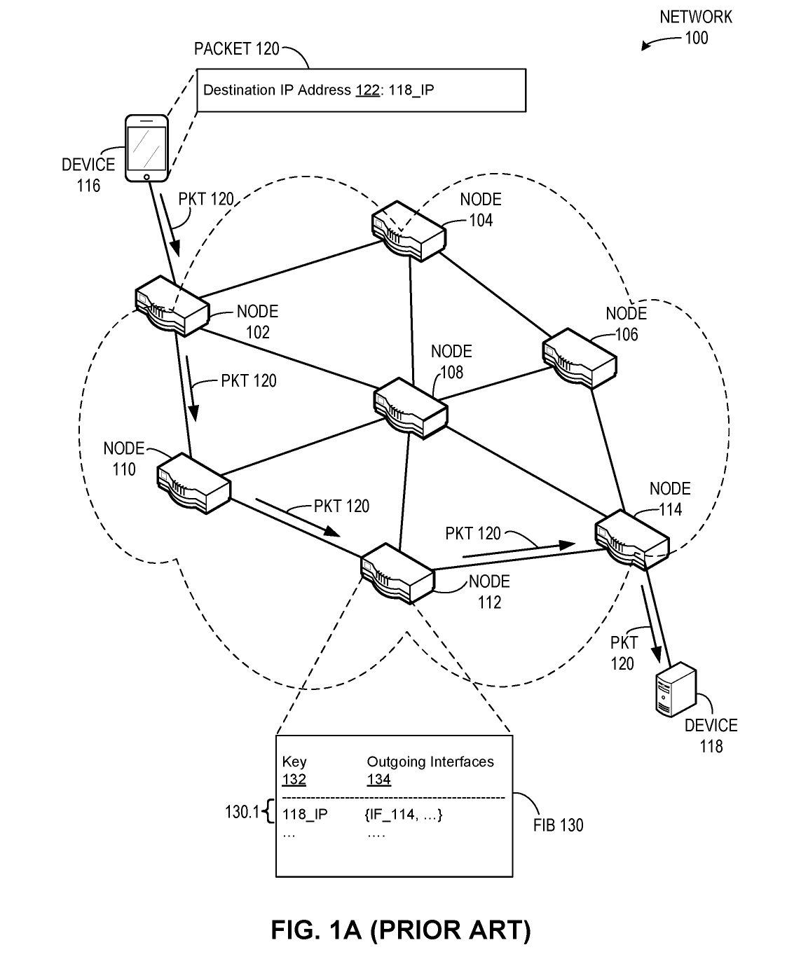

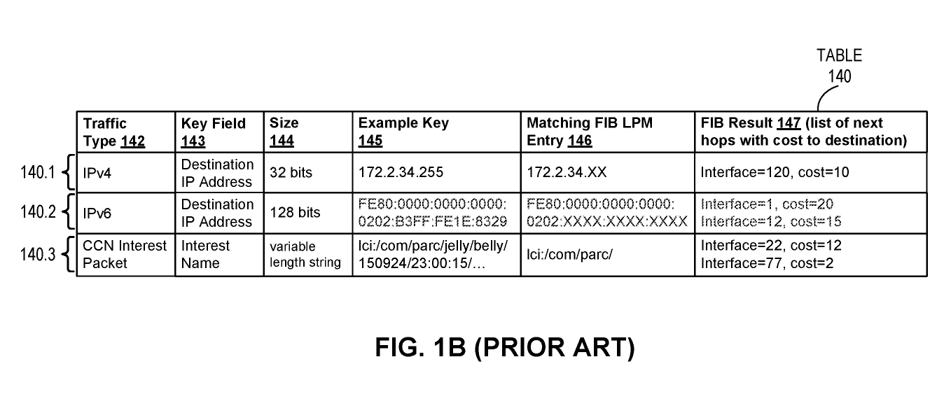

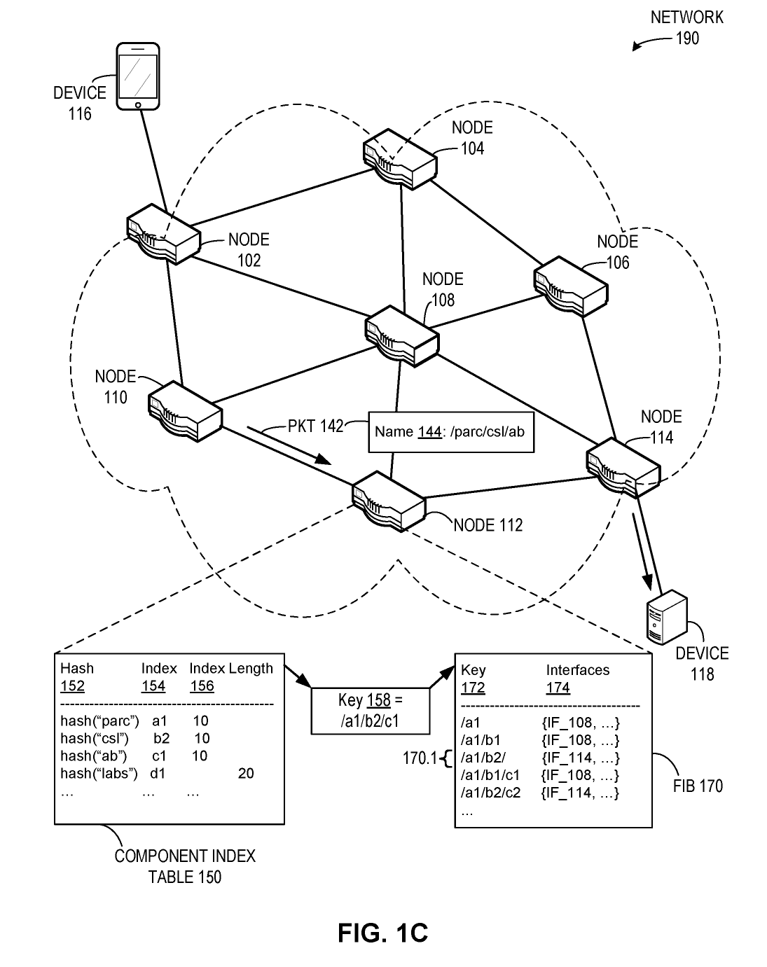

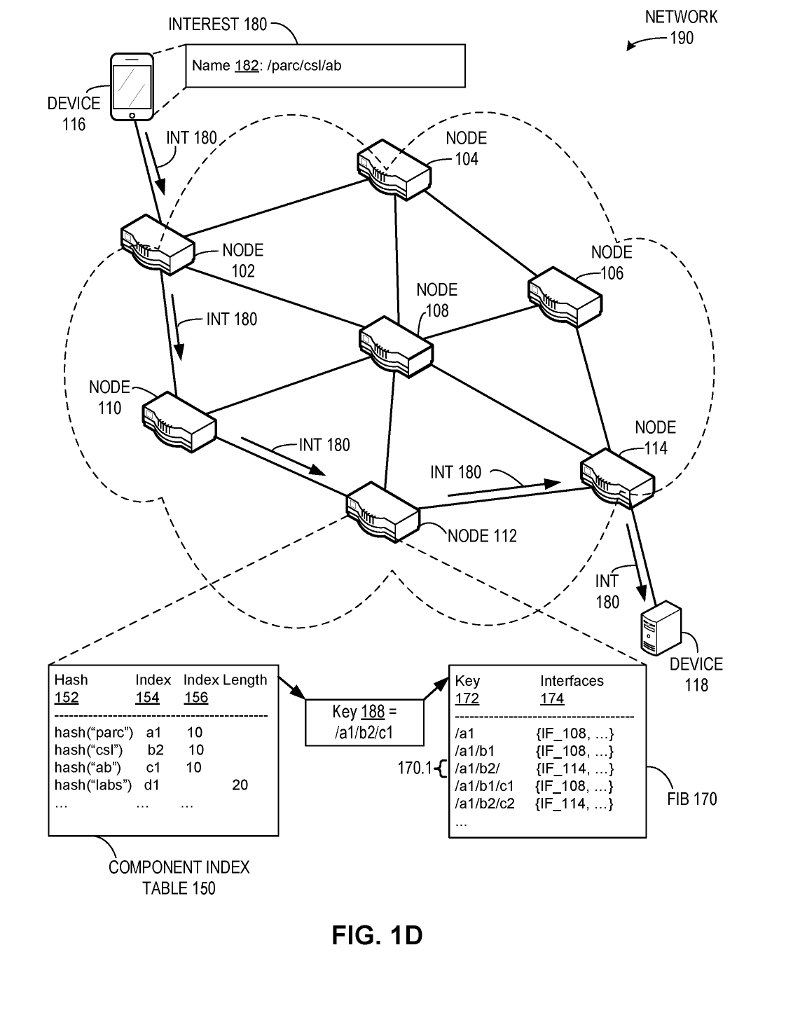

Embodiments of the present invention provide an architecture for a forwarding information base (FIB) of a typical IP router that allows the IP router to process both IP and CCN packets. The FIB is a data structure used by both IP and CCN routers. The FIB translates destination information from an incoming packet to a list of neighbors (e.g., outgoing interfaces or next-hop nodes) to which the incoming packet is to be sent. FIB lookups in IP and CCN both use a longest prefix match (LPM) to select the best FIB entry. In IP, the LPM best entry is the one with the longest subnet mask. In CCN, the LPM best entry is the one that completely matches the start of the interest name and includes the most number of name components. A name component match in CCN based on LPM is binary, that is, it either matches or it does not match. There is no partial match. Exemplary FIB lookups in IPv4, IPv6, and CCN are described below in relation to FIG. 1B.

Generally, the system of the present invention includes operations conducted in the control plane (e.g., routing updates based on a routing protocol) as well as operations conducted in the data plane (e.g., processing an incoming CCN packet and making a forwarding decision for the CCN packet based on the previously updated FIB).

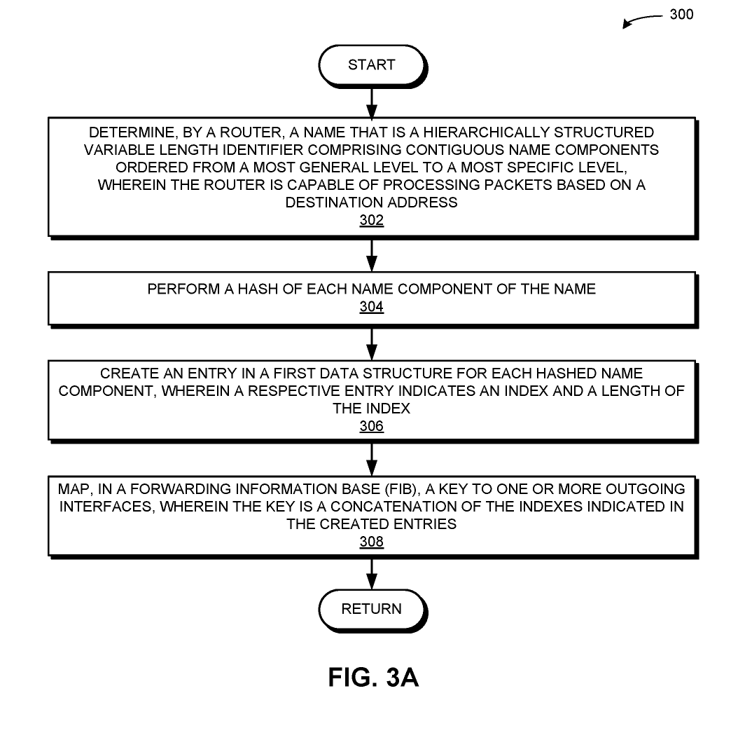

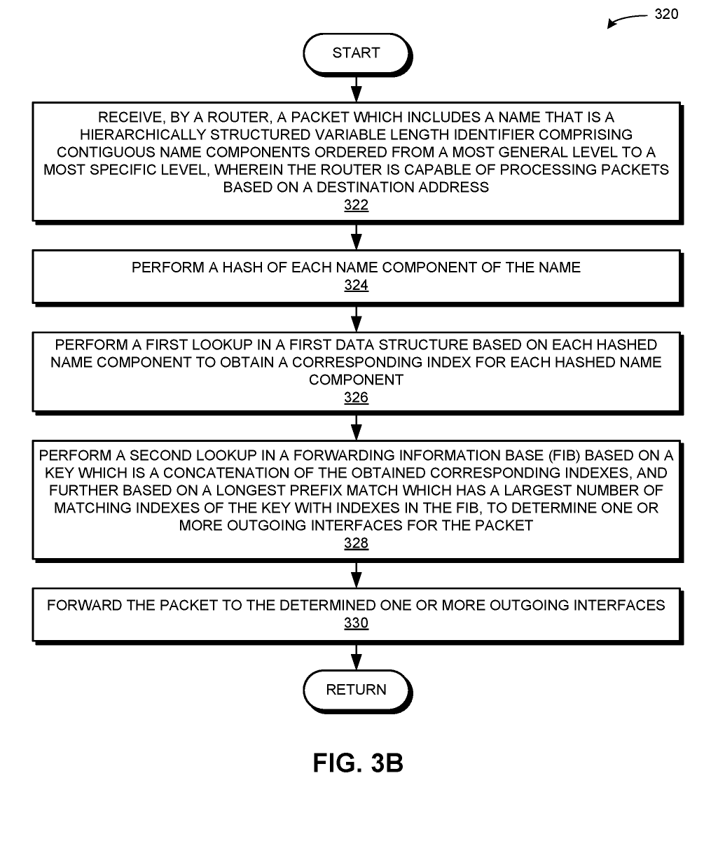

Specifically, during operation, a routing protocol can populate the FIB of a router by: taking a given name (e.g., an HSVLI comprised of contiguous name components); performing a hash on each name component; creating an entry in a component index table for each hashed name component, wherein a respective entry includes an index and a length of the index; and mapping, in the FIB, a key which is a concatenation of the indexes of the created entries. FIB population is described below in relation to FIG. 3A. Subsequently, the router can process and forward an incoming CCN packet with a name. The router can: receive a packet with a name (e.g., an HSVLI comprised of contiguous name components); perform the same hash of each name component; perform a first lookup in the component index table to obtain the index for each hashed name component; perform a second lookup in the FIB based on a key which is a concatenation of the obtained indexes to determine one or more outgoing interfaces for the packet, and based on LPM; and forward the packet to the one or more outgoing interfaces. Forwarding a CCN packet (by an IP router) is described below in relation to FIG. 3B.

Thus, the present system provides improvements to the distribution of digital content, where the improvements are fundamentally technological. Embodiments of the present invention provide a technological solution (e.g., providing a FIB architecture for IP routers that allows the IP routers to process both address-based IP packets and name-based CCN packets) to the technological problem of the efficient, secure, and effective distribution of digital content.

In CCN, each piece of content is individually named, and each piece of data is bound to a unique name that distinguishes the data from any other piece of data, such as other versions of the same data or data from other sources. This unique name allows a network device to request the data by disseminating a request or an interest that indicates the unique name, and can obtain the data independent from the data's storage location, network location, application, and means of transportation. The following terms are used to describe the CCN architecture:

Content Object (or “content object”): A single piece of named data, which is bound to a unique name. Content Objects are “persistent,” which means that a Content Object can move around within a computing device, or across different computing devices, but does not change. If any component of the Content Object changes, the entity that made the change creates a new Content Object that includes the updated content, and binds the new Content Object to a new unique name.

Unique Names: A name in a CCN is typically location independent and uniquely identifies a Content Object. A data-forwarding device can use the name or name prefix to forward a packet toward a network node that generates or stores the Content Object, regardless of a network address or physical location for the Content Object. In some embodiments, the name may be a hierarchically structured variable-length identifier (HSVLI). The HSVLI can be divided into several hierarchical components, which can be structured in various ways. For example, the individual name components parc, home, ccn, and test.txt can be structured in a left-oriented prefix-major fashion to form the name “/parc/home/ccn/test.txt.” Thus, the name “/parc/home/ccn” can be a “parent” or “prefix” of “/parc/home/ccn/test.txt.” Additional components can be used to distinguish between different versions of the content item, such as a collaborative document. The HSVLI can also include contiguous name components ordered from a most general level to a most specific level.

In some embodiments, the name can include an identifier, such as a hash value that is derived from the Content Object's data (e.g., a checksum value) and/or from elements of the Content Object's name. A description of a hash-based name is described in U.S. patent application Ser. No. 13/847,814, which is herein incorporated by reference. A name can also be a flat label. Hereinafter, “name” is used to refer to any name for a piece of data in a name-data network, such as a hierarchical name or name prefix, a flat name, a fixed-length name, an arbitrary-length name, or a label (e.g., a Multiprotocol Label Switching (MPLS) label).

Interest (or “interest”): A packet that indicates a request for a piece of data, and includes a name (or a name prefix) for the piece of data. A data consumer can disseminate a request or Interest across an information-centric network, which CCN/NDN routers can propagate toward a storage device (e.g., a cache server) or a data producer that can provide the requested data to satisfy the request or Interest.

Face or Interface (or “face” or “interface”): In CCN, the term “face” is a generalization of the concept of an interface. A face may be a connection to a network or directly to an application party. A face may be configured to send and receive broadcast or multicast packets on a particular network interface, or to send and receive packets using point-to-point addressing in the underlying transport, or using a tunnel (for example a TCP tunnel). A face may also be the connection to a single application process running on the same machine, via an encapsulation like UDP or an OS-specific inter-process communication path. All messages arrive through a face and are sent out through a face. In this disclosure, the term “neighbor” is interchangeable with the terms “face” and “interface,” referring to an incoming or outgoing interface of an Interest.

“Prefix”: In this disclosure, the term “prefix” can be used to refer to either a name of a specific content object or a name prefix for the content object. A routable name prefix can determine the routing of a packet that indicates a request for a piece of data, and includes a name (or a name prefix) for the piece of data. A data consumer can disseminate a request or interest across an information-centric network, which CCN/NDN routers can propagate toward a storage device (e.g., a cache server) or a data producer that can provide the requested data to satisfy the request or interest.

The methods disclosed herein are not limited to CCN networks and are applicable to other architectures as well. A description of a CCN architecture is described in U.S. patent application Ser. No. 12/338,175, which is herein incorporated by reference.

### Exemplary Network and Communication

A router operating on Internet Protocol (i.e., an IP router) typically processes a packet based on a destination address indicated in the IP packet. FIG. 1A illustrates an exemplary network 100 which facilitates forwarding an IP packet based on a destination address, in accordance with the prior art. Network 100 can include a consumer or content requesting device 116, a producer or content producing device 118, and a router or other forwarding device at nodes 102, 104, 106, 108, 110, 112, and 114. A node can be a computer system, an end-point representing users, and/or a device that can generate interests or originate content. A node can also be an intermediate node, including an edge router (e.g., nodes 102, 104, and 114) or a core router (e.g., nodes 106, 108, 110, and 112). Network 100 can be a content centric network or an IP network or a network which includes a mix of CCN and IP nodes.

Device 118 can send a packet 120 with a destination IP address 122 of “118_IP,” which is the IP address for device 118. Destination IP address 122 can be, e.g., 192.168.30.2. Packet 120 can be an IP packet which travels through network 100 via intermediate nodes 102, 110, 112, 114 before reaching destination device 118. Each router that receives packet 120 can forward packet 120 based on information in its respective FIB. For example, node 112 can include a FIB 130 with entries that include a key 132 and outgoing interfaces 134. Node 112 can receive packet 120, perform a lookup in FIB 130 based on a key that is the destination IP address included in packet 120 (i.e., “118_IP”) and determine that the list of corresponding outgoing interfaces for this destination IP address is “{IF_114, . . . }.” Node 112 can then forward packet 120 to the output port or interface associated with IF_114 (which is towards node 114). As described below, FIB 130 can be implemented in Ternary Content Addressable Memory (TCAM), where the destination IP address is used as input into a TCAM table based on LPM to return an index, and where the index is subsequently used as input into a standard SRAM or DRAM to obtain the list of next-hop nodes (i.e., outgoing interfaces).

FIG. 1B illustrates an exemplary table 140 of FIB lookups in IPv4, IPv6, and CCN, in accordance with the prior art. Table 140 includes entries with the following fields: a traffic type 142; a key field 143; a size 144; an example key 145; a matching FIB LPM entry 146; and a FIB result 147 which is a list of next-hop nodes with the cost to the destination. Specifically, table 140 includes: an entry 140.1 corresponding to an IPv4 packet; an entry 140.2 corresponding to an IPv6 packet; and an entry 140.3 corresponding to a CCN interest packet. As described above, an IP router which processes IP packets is currently unable to also process CCN packets. Embodiments of the present invention solve this problem by providing the following modified FIB architecture.

FIG. 1C illustrates an exemplary network 190 which facilitates forwarding a mix of IP packets and CCN packets, including control plane activity, in accordance with an embodiment of the present invention. During operation, a routing protocol can populate the respective FIBs for participating routers. For example, node 112 can receive a routing update, e.g., via a packet 142 which indicates an update for a name 144 of “/parc/csl/ab.” Name 144 can be an HSVLI comprised of contiguous name components ordered from a most general level to a most specific level. Node 112 can parse the name components of name 144, perform a hash function on each name component, create an entry in a component index table (CIT) 150 (where each entry includes an index), and map (in the FIB) a concatenation of the created indexes for the name components to outgoing interfaces. CIT 150 can be a hash table and an index table that includes entries with a hash 152, an index 154, and an index length 156. FIB 170 can include a key 172 and corresponding interfaces 174.

Specifically, node 112 can hash name component “parc” to obtain index “a1” with an index length of “10.” Similarly, node 112 can hash name component “csl” to obtain index “b2” with an index length of “10,” and can hash name component “ab” to obtain index “c1” with an index length of “10.” CIT 150 can include an existing entry for the name component “labs” with an index of “d1” and an index length of “20.” Node 112 can perform a key generation function, by concatenating the obtained indexes in the same order as the corresponding name components of the name. That is, node 112 can generate a key 158 (for name 144) which has a format of “/a1/b2/c1” (as shown) or “{a1; b2; c1}” (not shown) or any other format which indicates a concatenation of strings.

Node 112 can then map key 158 to one or more outgoing interfaces in its FIB 170. For example, node 112 can create (or update) an entry 170.1 based on key 158. Entry 170.1 can have a key of “/a1/b2” and outgoing interfaces of “{IF_114, . . . }.” Note that a FIB key may not include all the name components of a generated key. The routing protocol can determine how many name components may be used in a key for a FIB entry, and the LPM method can yield the result with the largest number of matching name components (or in this case, the largest number of matching indexes). Thus, FIG. 1C illustrates how the routing protocol can populate the FIB of an IP router so that the IP router can subsequently process CCN packets, as described below in relation to FIG. 1D. Note that the FIB can also be populated by an IP routing protocol which inserts entries into FIB 170 based on a key which is an IP destination address and returns a corresponding LPM entry. For example, example keys 145 of entries 140.1 and 140.2 may be inserted into FIB 170 to correspond to matching FIB LPM entries 146 of entries 140.1 and 140.2, just as key 132 of entry 130.1 may be inserted into FIB 130 to correspond to outgoing interfaces 134 of entry 130.1.

FIG. 1D illustrates an exemplary network 190 which facilitates forwarding a mix of IP packets and CCN packets, including data plane activity, in accordance with an embodiment of the present invention. The communications described in FIG. 1D can occur after the communications described above for FIG. 1C. That is, the routing protocol can previously populate both CIT 150 and FIB 170 as shown. During operation, device 116 can generate an interest 180 with a name 182 of “/parc/csl/ab.” Interest 180 can travel through network 190 via nodes 102, 110, 112, 114 before reaching producer device 118. Each router that receives interest 180 can forward interest 180 based on information in its respective CIT and FIB. For example, node 112 can include CIT 150 and FIB 170. Node 112 can receive and process interest 180 in a similar fashion as that shown for the control plane activity in FIG. 1C. Node 112 can parse the name components of name 182. Node 112 can perform a hash function on each name component, and perform a first lookup in CIT 150 based on each hashed name component to obtain the index for each hashed name component. Node 112 can then perform a second lookup in FIB 170 based on a key (i.e., key 188) which is a concatenation of the obtained indexes, and based on LPM, to determine corresponding outgoing interfaces (i.e., as indicated in entry 170.1). Node 112 can then forward interest 180 to the determined interfaces (i.e., IF_114, etc.).

### Exemplary Interests, Index Tables, Keys, and Forwarding Information Bases

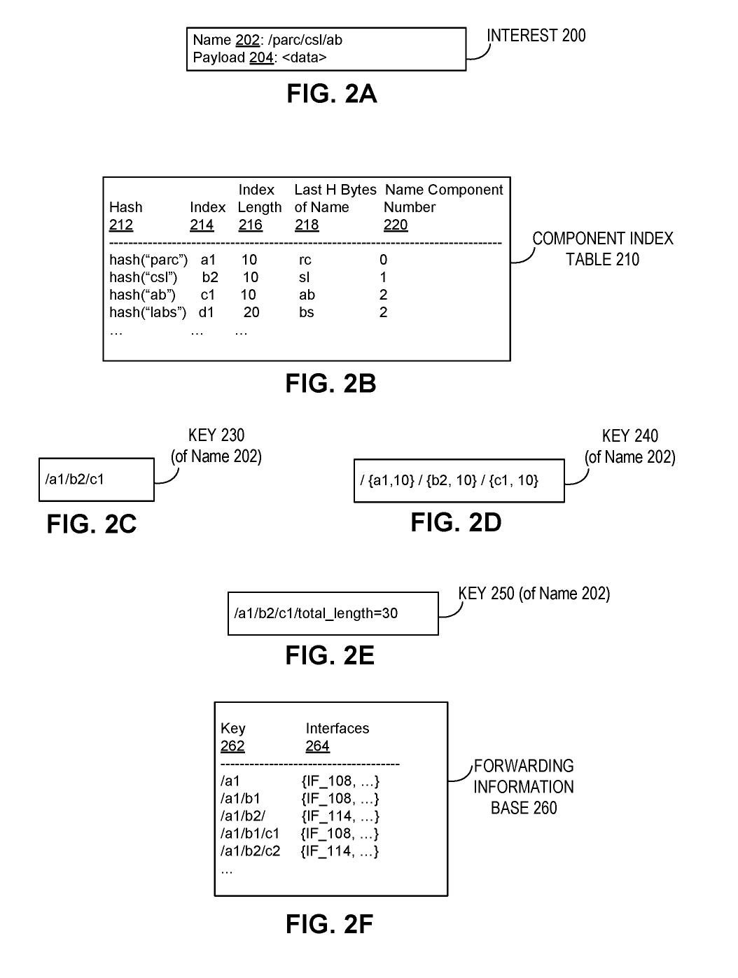

FIG. 2A illustrates an exemplary CCN interest 200, in accordance with an embodiment of the present invention. Interest 200 can include a name 202 of “/parc/csl/ab” and an optional payload 204 of “<data>.” Name 202 can be an HSVLI, as described above.

FIG. 2B illustrates an exemplary component index table (CIT) 210, in accordance with an embodiment of the present invention. CIT 210 can include entries with a hash 212, an index 214, an index length 216, a last H bytes of the name 218, and a name component number 220. H can be a predetermined number, such as 2. Thus, the last H (or 2) bytes of the name “parc” are “rc.” The name component number can indicate the order of the name component within the name. For example, in a zero-based order, for name 202 of interest 200, the hash of the name component “/csl” can have an index of “b2”, an index length of “10,” a last H bytes of the name of “sl,” and a name component number of “1.” The last H bytes of the name and the name component number are values that can be used to accurately determine the corresponding index for an incoming packet name.

FIG. 2C illustrates an exemplary key 230 based on name 202 for interest 200 in FIG. 2A, in accordance with an embodiment of the present invention. Key 230 can include the indexes of the corresponding name components of name 202 in the same order, e.g., “/a1/b2/c2.”

FIG. 2D illustrates an exemplary key 240 based on name 202 for interest 200 in FIG. 2A, in accordance with an embodiment of the present invention. Key 240 can include the index length as part of a tuple comprising each index and the index length, e.g., “/{a1,10}/{b2, 10}/{c1, 10}.”

FIG. 2E illustrates an exemplary key 250 based on name 202 for interest 200 in FIG. 2A, in accordance with an embodiment of the present invention. Key 250 can include the indexes of the corresponding name components of name 202 as well as the total length of the indexes, e.g., “/a1/b2/c1/total_length=30.” Key 250 (as well as key 230 and key 240) can be used as input into a FIB to determine an LPM result. The total length of the key (i.e., the cumulative lengths of the constituent indexes included in, and concatenated to form, the key) must be less than the width supported by the LPM. The LPM matches the actual bits of the key with the bits in the key field of the FIB, and returns the entry with the greatest number of fully matching indexes. That is, similar to the LPM result in CCN for an HSVLI comprised of contiguous name components (strings), a match for an individual index in the FIB based on LPM is binary and either matches or does not match.

FIG. 2F illustrates an exemplary forwarding information base (FIB) 260, in accordance with an embodiment of the present invention. FIB 260 can include entries with a key 262 and interfaces 264, which can be the corresponding outgoing interfaces or output ports associated with the next-hop neighbors to which the packet with key 262 is to be sent.

### Exemplary FIB Implementations in IP and CCN

An IP FIB of a high speed router can be implemented in Ternary Content Addressable Memory (TCAM). A TCAM is a specialized type of high-speed memory that searches its entire contents in a single clock cycle. The term “ternary” refers to the memory's ability to store and query data using three different inputs: 0, 1, and X. The “X” input (which is often referred to as a “don't care” or “wildcard” state) enables TCAM to perform broader searches based on pattern matching, as opposed to binary CAM, which performs exact-match searches using only 0s and 1s. A TCAM can also support pattern match applications such as ACLs or Ethernet lookups, but require dedicated hardware, consume significant power, and do not scale past O(1M) entries.

Each entry in the IP FIB based on LPM is inserted into the table with bits beyond the subnet mask bits set to X (wildcard). The destination IP value is then checked against all TCAM entries. The matching entry with the longest prefix (i.e., the smallest number of X bits) is the best match. The TCAM returns an index, which is used to access a standard SRAM or DRAM containing the result, which is a list of next-hop routers and the corresponding cost to reach the destination for each of the listed next-hops. The router can then select a next-hop and resolve the next-hop to an output interface (outgoing interface) to which the packet is sent.

LPM can also be implemented using information retrieval trees, also known as TRIEs (e.g., P-TRIE, M-TRIE, and B-TREE). TRIE-based approaches can be implemented in less expensive DRAM but can be slower because multiple lookups are needed to traverse the tree and can be more complex to manage.

A CCN FIB of a high speed router can be implemented using a TRIE-based approach, where searches are conducted based on the packet name (as described in Wang, et al., “Scalable Name Lookup in NDN Using Effective Name Component Encoding,” ICDCS '12 Proceedings of the 2012 IEEE 32nd International Conference on Distributed Computing Systems, at pages 688-697). However, this approach may be too slow for high speed routers because multiple lookups are needed to traverse the tree. CCN FIBs can also be implemented based on chained hash tables (as described in Mosko, “A CCN Forwarding Design for a Network Processor,” IEEE ICC 2015), but this approach may also be too slow due to the number of lookups required (as described in So, et al, “NDN on a Routers: Fast and DoS-resistant Forwarding with Hash Tables,” Architectures for Networking and Communications Systems (ANCS), 2013 ACM/IEEE Symposium, October 2013). CCN FIBs can also be implemented based on algorithms which combine bloom filters and hash memories (as described in Perino, et al, “Caesar: A Content Router for High-Speed Forwarding on Content Names,” ACM/IEEE Symposium on Architectures for Networking and Communications Systems, October 2014). While these approaches are fast and scale well with dedicated hardware to compute the bloom hashes, these approaches do not support IP because IP has a subnet field.

Embodiments of the present invention include implementing the CCN FIB in TCAM, though other implementations are possible. Recall that TCAM is commonly used for IP FIBs based on LPM. The scale limitations of TCAM may present issues, such as applications requiring high speed routers with TCAM-compatible FIB s. Two such examples include an intra-datacenter router and a core network router where a strong name hierarchy is enforced.

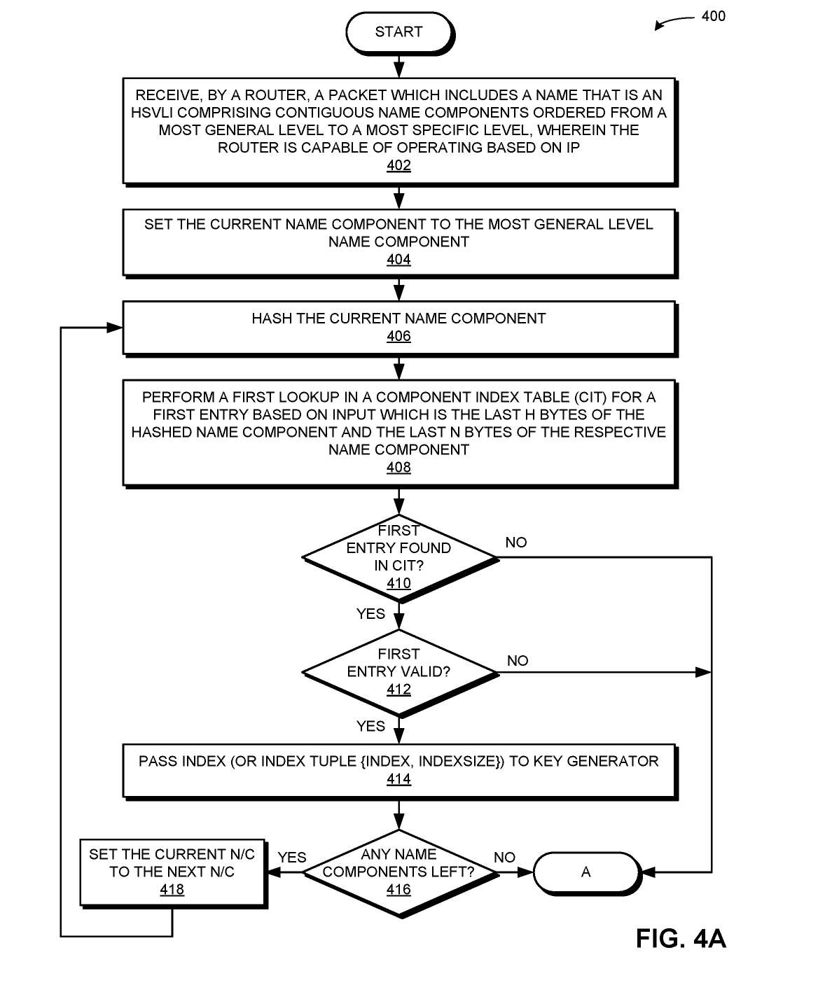

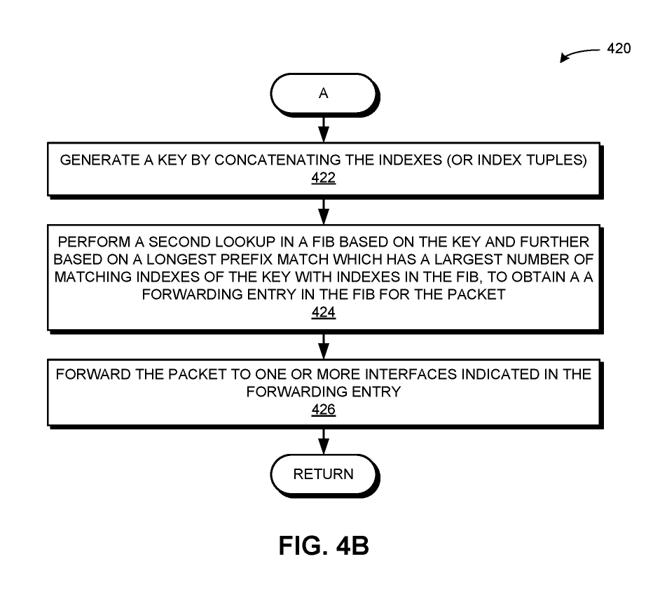

A TCAM entry consists of 64-640 ternary bits. The large number of bits per entry allows for uses including IPv6 LPM, or 5 tuple matching for Access Control Lists. A CCN interest name string length can exceed 80 characters supported by even a 640 bit TCAM entry. However, because the namespace usage may be sparse, name strings may be compressed into more compact representations. An embodiment using TCAM and a cuckoo hash is described below in relation to FIGS. 4A and 4B.

### IP Router Facilitates Forwarding a Mix of IP and CCN Packets

FIG. 3A presents a flow chart 300 illustrating a method by a router for facilitating forwarding a mix of IP and CCN packets, including updating the FIB based on a routing protocol, in accordance with an embodiment of the present invention. During operation, the system determines, by a router, a name that is an HSVLI comprising contiguous name components ordered from a most general level to a most specific level, wherein the system is capable of processing packets based on a destination address (operation 302). The system can be a router capable of processing IP packets or capable of operating based on IP. The system performs a hash of each name component of the name (operation 304). The system creates an entry in a first data structure for each hashed name component (operation 306). A respective entry indicates an index and a length of the index. Subsequently, the system maps, in a FIB, a key to one or more outgoing interfaces, wherein the key is a concatenation of the indexes indicated in the created entries (operation 308). This facilitates the system to process packets based on the packet name or on a destination address.

FIG. 3B presents a flow chart 320 illustrating a method by a router for facilitating forwarding a mix of IP and CCN packets, including processing an incoming interest, in accordance with an embodiment of the present invention. The operations described in FIG. 3B occur after a routing protocol has populated or updated the FIB of a receiving router (i.e., the control plane activity described in relation to FIGS. 1C and 3A). During operation, the system receives, by a router, a packet which includes a name that is an HSVLI comprising contiguous name components ordered from a most general level to a most specific level (operation 322). Similar to the system described in FIG. 3A, the system of FIG. 3B can be a router capable of processing IP packets (i.e., based on a destination IP address) or capable of operating based on IP. The system performs a hash of each name component of the name (operation 324). The hash is the same hash function performed in operation 304 of FIG. 3A.

The system performs a first lookup in a first data structure based on each hashed name component to obtain a corresponding index for each hashed name component (operation 326). The system performs a second lookup in the FIB based on a key which is a concatenation of the obtained corresponding indexes, and further based on a longest prefix match which has a largest number of matching indexes of the key with indexes in the FIB, to determine one or more outgoing interfaces for the packet (operation 328). Subsequently, the system forwards the packet to the determined one or more outgoing interfaces (operation 330).

### Exemplary Process for Facilitating Forwarding Mix of IP and CCN Packets

FIG. 4A presents a flow chart 400 illustrating a method by a router for facilitating forwarding a mix of IP and CCN packets, based on a specific embodiment that includes a cuckoo hash, truncated hash values, and final bits of a respective name component, in accordance with an embodiment of the present invention. During operation, the system receives, by a router, a packet which includes a name that is an HSVLI comprising contiguous name components ordered from a most general level to a most specific level (operation 322). The router is capable of processing IP packets (i.e., based on a destination IP address) or capable of operating based on IP. The router sets the current name component to the most general level name component (operation 404). The router performs a hash of the current name component (operation 406).

The router performs a first lookup in a component index table (CIT) for a first entry based on input which is the last H bytes of the hashed name component and the last N bytes of the respective name component (operation 408). H is a first predetermined number, and N is a second predetermined number. If the first entry is not found in the CIT (decision 410), the operation continues as described at Label A of FIG. 4B. If the first entry is found in the CIT (decision 410), the router determines whether the first entry is valid (decision 412). The first entry is valid if the router obtains a valid tuple of {Index, IndexSize, Last N bytes of Name} and if the last N bytes of the packet name match the value for the “Last N Bytes of Name” in the obtained valid tuple. If the first entry is not valid (decision 412), the operation continues as described at Label A of FIG. 4B. If the first entry is valid, the system passes the index (or the index tuple of {Index, IndexSize}) to a key generator (operation 414). The key generator can be a separate module or unit inside the FIB, or can comprise a process or function performed by the FIB. The key generator can store the passed index in, e.g., temporary storage.

The router determines whether any name components are left (decision 416) (e.g., whether there is a “next” name component to process). If there are name components left, the router sets the current name component to the next name component (operation 418), and the operations continues at operation 406 for that next name component. If there are no more name components left, the operation continues as described at Label A of FIG. 4B.

FIG. 4B presents a flow chart 420 illustrating a method by a router for facilitating forwarding a mix of IP and CCN packets, based on a specific embodiment that includes a cuckoo hash, truncated hash values, and final bits of a respective name component, in accordance with an embodiment of the present invention. During operation, the router generates a key by concatenating the indexes (or index tuples) (operation 422). The router, via a key generator module or function, can generate the key by accessing a temporary storage which includes the indexes (or index tuples) received to date (i.e., passed to the key generator after the first lookup in the CIT for each respective hashed name component). The router performs a second lookup in its FIB based on the key (i.e., the concatenation of the obtained corresponding indexes), and further based on a longest prefix match which has a largest number of matching indexes of the key with indexes in the FIB, to obtain a forwarding entry in the FIB for the packet (operation 424). Subsequently, the system forwards the packet to one or more interfaces indicated in the forwarding entry (operation 426).

FIGS. 4A and 4B describe an embodiment which uses a cuckoo hash. String compression based on a cuckoo hash may result in collisions when two different name components in the (uncompressed) FIB have the same value. The system can detect these collisions upon creating entries in the CIT. Because two hash functions are used in the cuckoo hash, each name component will have a unique entry if the table size is sufficiently large. String compression may also result in collisions when a name component in an incoming packet hashes to the same value as a CIT entry with a different name. The system can detect these collisions by comparing the last H bytes of the incoming packet name with the last H bytes indicated in the CIT entry (as in decision 412, above). If the comparison yields a mismatch, the packet is discarded (or stops processing indexes, as described in operation 422 above).

Embodiments based on other types of hash functions are also possible. One example is a dual hash with a collision avoidance table (CAT), where an intermediate table is used to switch hash functions in the event of a collision between two FIB entries. During initialization, the CAT is populated so that if no collision occurs on a primary hash value, the primary hash value is used as the component index. If a collision does occur, the primary hash value is used for one name and the secondary hash value is used for the other name. A primary/secondary bit is added to the component index so that the primary and secondary hash indexes are unique. In such an embodiment, the intermediate hash table contains one bit to indicate collision, and at least one byte from each of the two components that indicate the corresponding hash function.

### Exemplary Computer System

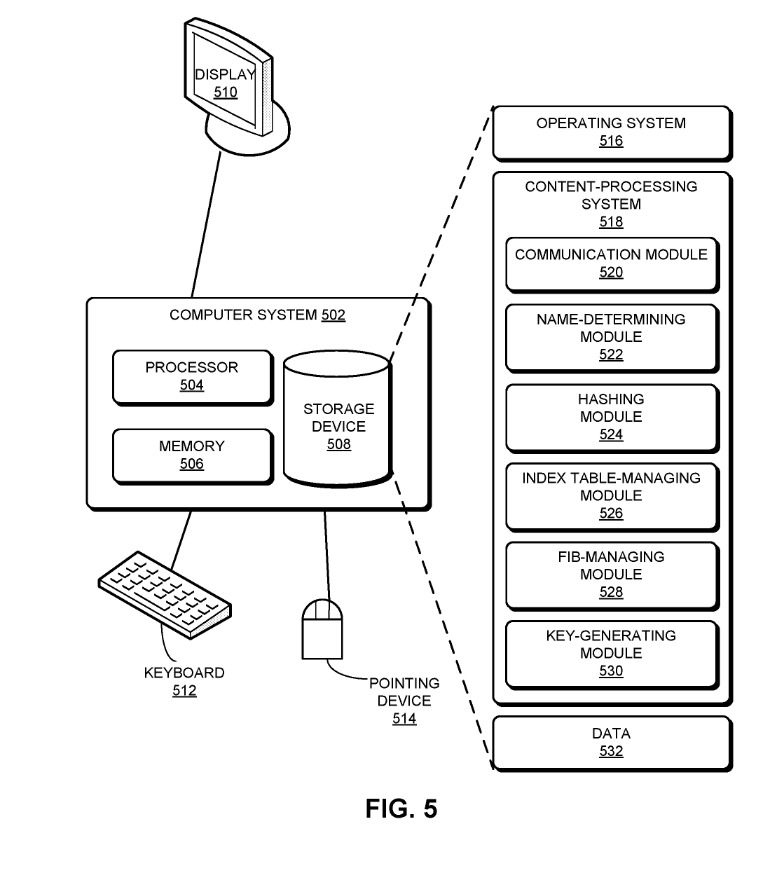

FIG. 5 illustrates an exemplary computer system 502 that facilitates forwarding a mix of IP packets and CCN packets, in accordance with an embodiment of the present invention. Computer system 502 includes a processor 504, a memory 506, and a storage device 508. Memory 506 can include a volatile memory (e.g., RAM) that serves as a managed memory, and can be used to store one or more memory pools. Furthermore, computer system 502 can be coupled to a display device 510, a keyboard 512, and a pointing device 514. Storage device 508 can store an operating system 516, a content-processing system 518, and data 532.

Content-processing system 518 can include instructions, which when executed by computer system 502, can cause computer system 502 to perform methods and/or processes described in this disclosure. Specifically, content-processing system 518 may include instructions for sending and/or receiving IP or CCN data packets to/from other network nodes across a computer network, such as an IP or a content centric network (communication module 520). A data packet can include an interest packet or a content object packet with a name which is an HSVLI that includes contiguous name components ordered from a most general level to a most specific level.

Further, content-processing system 518 can include instructions for determining a name which is an HSVLI (name-determining module 522). Content-processing system 518 can also include instructions for performing a hash of each name component of the name (hashing module 524). Content-processing system 518 can include instructions for creating an entry in a first data structure for each hashed name component (index table-managing module 526). Content-processing system 518 can include instructions for mapping in a FIB a key which is a concatenation of indexes indicated in the created entries (FIB-managing module 528).

Content-processing system 518 can include instructions for, in response to determining a hash collision in the first data structure, resolving the collision based on a cuckoo hash function or a collision avoidance table (hashing module 524). Content-processing system 518 can include instructions for generating the key by concatenating the indexes in a same order as the corresponding name components of the name (key-generating module 530).

Content-processing system 518 can include instructions for receiving a packet which includes the name (communication module 520) and performing a hash of each name component (hashing module 524). Content-processing system 518 can include instructions for performing a first lookup in the first data structure for each hashed name component (index table-managing module 526), and for performing a second lookup in the FIB based on a key which is a concatenation of indexes from the first data structure for each hashed name component to determine outgoing interfaces for the packet (FIB-managing module 528). Content-processing system 518 can include instructions for forwarding the packet to the outgoing interfaces (communication module 520).

Data 532 can include any data that is required as input or that is generated as output by the methods and/or processes described in this disclosure. Specifically, data 532 can store at least: an interest; a content object; a name; a name that is an HSVLI comprising contiguous name components ordered from a most general level to a most specific level; a routable prefix or a name prefix that indicates one or more contiguous name components beginning from the most general level; a hash function; a dual hash function; a cuckoo hash function; a collision avoidance table; a name component; a hashed name component; a data structure; a component index table (CIT); a CIT entry; a CIT entry which indicates a final predetermined number of bytes of a respective name component, an index, and a length of the index; an index; an index length; a FIB; a FIB based on a TCAM; a key; a concatenation of indexes; an index tuple comprising the index and the index length; an indicator of one or more outgoing interfaces; a longest prefix match algorithm process or method; a first predetermined number of bytes of a hashed name component; a second predetermined number of bytes of a name component; and a tuple comprised of the index, the index length, and the final second predetermined number of bytes of a name component.

The data structures and code described in this detailed description are typically stored on a computer-readable storage medium, which may be any device or medium that can store code and/or data for use by a computer system.

The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer system comprising:
a processor; and
a storage device storing instructions that when executed by the processor cause the processor to perform a method, the method comprising:
determining a name which is a hierarchically structured variable length identifier comprising contiguous name components ordered from a most general level to a most specific level, wherein the computer system is capable of processing packets based on a destination address;
performing a hash of each name component;
creating an entry in a first data structure for each hashed name component, wherein a respective entry indicates an index and a length of the index; and
mapping, in a forwarding information base, a first key to one or more outgoing interfaces, wherein the first key is a concatenation of the indexes indicated in the created entries,
thereby facilitating the computer system to process packets based on the packet name or on the destination address.

2. The computer system of claim 1, wherein the respective entry indicates a final predetermined number of bytes of a respective name component, wherein the hash is a dual hash function, and wherein performing the hash further comprises:
in response to determining a collision in the first data structure, resolving the collision based on a cuckoo hash function or a collision avoidance table.

3. The computer system of claim 1, wherein the method further comprises:
generating the key by concatenating the indexes in a same order as the corresponding name components of the name.

4. The computer system of claim 1, wherein the forwarding information base is based on a Ternary Content Addressable Memory.

5. The computer system of claim 1, where the method further comprises:
receiving a packet which includes the name;
performing the hash of each name component;
performing a first lookup in the first data structure based on each hashed name component to obtain the indicated index for each hashed name component;
performing a second lookup in the forwarding information base based on a second key which is a concatenation of the indicated indexes, and further based on a longest prefix match which has a largest number of matching indexes of the key with indexes in the forwarding information base, to determine one or more outgoing interfaces for the packet; and
forwarding the packet to the determined one or more outgoing interfaces.

6. The computer system of claim 5, wherein performing the first lookup is further based on the last H bytes of each hashed name component and the last N bytes of the name component,
wherein H is a first predetermined number, and wherein N is a second predetermined number.

7. The computer system of claim 6, wherein obtaining the indicated index for a respective hashed name component further involves:
obtaining a valid tuple comprised of the index, the length of the index, and the last N bytes of the respective name component; and
determining that the last N bytes of the respective name component of the valid tuple match the last N bytes of the respective name component.

8. A computer-implemented method, comprising:
determining, by a router, a name which is a hierarchically structured variable length identifier comprising contiguous name components ordered from a most general level to a most specific level, wherein the router is capable of processing packets based on a destination address;
performing a hash of each name component;
creating an entry in a first data structure for each hashed name component, wherein a respective entry indicates an index and a length of the index; and
mapping, in a forwarding information base, a first key to one or more outgoing interfaces, wherein the first key is a concatenation of the indexes indicated in the created entries,
thereby facilitating the computer system to process packets based on the packet name or on the destination address.

9. The method of claim 8, wherein the respective entry indicates a final predetermined number of bytes of a respective name component, wherein the hash is a dual hash function, and wherein performing the hash further comprises:
in response to determining a collision in the first data structure, resolving the collision based on a cuckoo hash function or a collision avoidance table.

10. The method of claim 8, further comprising:
generating the key by concatenating the indexes in a same order as the corresponding name components of the name.

11. The method of claim 8, wherein the forwarding information base is based on a Ternary Content Addressable Memory.

12. The method of claim 8, further comprising:
receiving a packet which includes the name;
performing the hash of each name component;
performing a first lookup in the first data structure based on each hashed name component to obtain the indicated index for each hashed name component;
performing a second lookup in the forwarding information base based on a second key which is a concatenation of the indicated indexes, and further based on a longest prefix match which has a largest number of matching indexes of the key with indexes in the forwarding information base, to determine one or more outgoing interfaces for the packet; and
forwarding the packet to the determined one or more outgoing interfaces.

13. The method of claim 12, wherein performing the first lookup is further based on the last H bytes of each hashed name component and the last N bytes of the name component,
wherein H is a first predetermined number, and wherein N is a second predetermined number.

14. The method of claim 13, wherein obtaining the indicated index for a respective hashed name component further involves:
obtaining a valid tuple comprised of the index, the length of the index, and the last N bytes of the respective name component; and
determining that the last N bytes of the respective name component of the valid tuple match the last N bytes of the respective name component.

15. A non-transitory computer-readable storage medium storing instructions that when executed by a computer cause the computer to perform a method, the method comprising:
determining, by a router, a name which is a hierarchically structured variable length identifier comprising contiguous name components ordered from a most general level to a most specific level, wherein the router is capable of processing packets based on a destination address;
performing a hash of each name component;
creating an entry in a first data structure for each hashed name component, wherein a respective entry indicates an index and a length of the index; and
mapping, in a forwarding information base, a first key to one or more outgoing interfaces, wherein the first key is a concatenation of the indexes indicated in the created entries,
thereby facilitating the computer system to process packets based on the packet name or on the destination address.

16. The storage medium of claim 15, wherein the respective entry indicates a final predetermined number of bytes of a respective name component, wherein the hash is a dual hash function, and wherein performing the hash further comprises:
in response to determining a collision in the first data structure, resolving the collision based on a cuckoo hash function or a collision avoidance table.

17. The storage medium of claim 15, further comprising:
generating the key by concatenating the indexes in a same order as the corresponding name components of the name.

18. The storage medium of claim 15, wherein the forwarding information base is based on a Ternary Content Addressable Memory.

19. The storage medium of claim 15, wherein the method further comprises:
receiving a packet which includes the name;
performing the hash of each name component;
performing a first lookup in the first data structure based on each hashed name component to obtain the indicated index for each hashed name component;
performing a second lookup in the forwarding information base based on a second key which is a concatenation of the indicated indexes, and further based on a longest prefix match which has a largest number of matching indexes of the key with indexes in the forwarding information base, to determine one or more outgoing interfaces for the packet; and
forwarding the packet to the determined one or more outgoing interfaces.

20. The storage medium of claim 19, wherein performing the first lookup is further based on the last H bytes of each hashed name component and the last N bytes of the name component,
wherein H is a first predetermined number, and wherein N is a second predetermined number, and
wherein obtaining the indicated index for a respective hashed name component further involves:
obtaining a valid tuple comprised of the index, the length of the index, and the last N bytes of the respective name component; and
determining that the last N bytes of the respective name component of the valid tuple match the last N bytes of the respective name component.
